(19) United States
(12) Patent Application Publication
(10) Pub. No.: US 2024/0210329 A1
(43) Pub. Date: Jun. 27, 2024

(54) METHOD FOR DETECTING ABNORMAL DEFECT ON STEEL SURFACE BASED ON SEMI-SUPERVISED CONTRASTIVE LEARNING

(71) Applicant: ZHEJIANG UNIVERSITY, Hangzhou (CN)

(72) Inventor: Haoji HU, Hangzhou (CN)

(21) Appl. No.: 18/395,776

(22) Filed: Dec. 26, 2023

(30) Foreign Application Priority Data
Dec. 27, 2022 (CN) 202211687353.4

(51) Int. Cl. G01N 21/88; G01N 21/956; G06T 7/00

(52) U.S. Cl. CPC G01N 21/8851; G01N 21/95607; G06T 7/001; G01N 2021/8887; G01N 2021/95615; G06T 2207/20081; G06T 2207/20084

(57) ABSTRACT

A method for detecting an abnormal defect on a steel surface based on semi-supervised contrastive learning. The method uses a semi-supervised contrastive learning defect detection network architecture based on “abnormality reconstruction+contrastive discriminative”. A pseudo abnormal sample is obtained by simulating abnormality of the normal sample, and then the abnormality reconstruction network is used to reconstruct and recover the pseudo abnormal sample. For the abnormal sample and the restored samples obtained after reconstruction, a contrastive learning optimization segmentation effect is formed based on the information of the two images by the subsequent contrastive discriminative networks. Secondly, the performance of the abnormality reconstruction network is better optimized by using the mask dilated convolution module and combining with modules based on Transformer. At the same time, a self-attention mechanism is added on the basis of the contrastive discriminative network to improve the network's contrastive learning ability in space and channels.

### CROSS-REFERENCE TO RELATED APPLICATIONS

The present application claims priority to Chinese Patent Application No. 202211687353.4, filed on Dec. 27, 2022, the content of which is incorporated herein by reference in its entirety.

### TECHNICAL FIELD

The present disclosure relates to fields such as industrial defect detection, semantic segmentation, and abnormality detection, and in particular, to a method for detecting an abnormal defect on a steel surface based on semi-supervised contrastive learning.

### BACKGROUND

The significant value of semantic segmentation algorithm is beyond doubt in the field of industrial defect detection. The industrial defect detection refers to the process of conducting certain industrial inspections before and after the production and processing process to ensure safety and quality for various products in the industry, such as aerospace vehicles and micro/nano level electronic components. Therefore, the industrial defect detection is a key link and technology for ensuring the quality of industrial products and production safety and stability.

However, the industrial defect detection technology based on semantic segmentation faces numerous challenges, which are closely related to the real environment of the industry. For example, insufficient sample resources for defects, unclear and incomplete definition of defect types, poor visibility of defects, and variable shapes of defects, etc. These problems have led to a series of technical difficulties in practical scenes, hindering the development of industrial defect detection. The specific problems are as follows: 1) it is difficult to annotate data in real industrial scenarios, and there is a large error in human annotation; 2) the amount of data annotation is limited, and the algorithm model relies heavily on the data; and 3) there are a large number of normal samples in real industrial scenes, while the number of abnormal samples is too small and the positive and negative samples are unbalanced.

### SUMMARY

An object of the present disclosure is to provide a method for detecting an abnormal defect on a steel surface based on semi-supervised contrastive learning for the shortcomings of existing semantic segmentation methods of the industrial defect detection.

The object of the present disclosure is achieved by the following technical solution: a method for detecting an abnormal defect on a steel surface based on semi-supervised contrastive learning. The method includes following steps:

Step (1), obtaining steel surface data in a real industrial scene, selecting images of machine tool area taken from different perspectives, taking data with a surface defect as an abnormal sample, and taking data without the surface defect as a normal sample, wherein the surface defect comprises edge cracks and creases.

Step (2), generating an abnormal Perlin noise simulating the real industrial scene by simulating abnormality for the normal sample, and combining with the normal sample equally scaled to obtain a simulated abnormal sample image I_{c}:

$${I}_{c} = {I}_{γ} ⊙ \overline{{P}_{t}} + β ( {I}_{r} ⊙ {P}_{t} ) + ( 1 - β ) ( A ⊙ {P}_{t} )$$

where Iᵣ represents a compressed image equally scaled for a normal sample image I, A is a texture pattern of a randomly simulated abnormality, and Pₜ is a binary image of a random Berlin noise image P, β represents a proportion coefficient, which is a fusion ratio between the normal sample image and a simulated abnormal defect, ⊙ represents a dot multiplication operation pixel by pixel between image matrices, and P̅ₜ̅ represents a reverse value image of an abnormal binary image Pₜ.

Step (3), constructing an abnormality reconstruction network based on an encoder-decoder structure for learning how to restore and reconstruct the abnormal sample into the normal sample, using the simulated abnormal sample of the step (2) as a network input, obtaining a reconstructed recovery sample, calculating a loss relative to the normal sample, and training the abnormality reconstruction network.

Step (4), constructing a contrastive discriminative network based on semantic segmentation, inputting the abnormal sample of the step (1) into the trained abnormality reconstruction network to obtain the reconstructed recovery sample, combining a channel with a input abnormal sample as an input of the contrastive discriminative network, obtaining a difference between the reconstructed recovery sample and the input abnormal sample by contrastive learning, and outputting a steel surface defect detection result.

In an embodiment of the present disclosure, a mask dilated convolution module is embedded in an encoder of the abnormality reconstruction network to expand a receptive field of the abnormality reconstruction network, and a transformer is used to replace a full connection integration operation of the mask dilated convolution module to achieve feature aggregation.

In an embodiment of the present disclosure, for the contrastive discriminative network, a self-attention mechanism module is used to obtain channel and spatial self-attention input by the contrastive discriminative network, so as to optimize the steel surface defect detection result.

In an embodiment of the present disclosure, for an input feature map of the contrastive discriminative network, attention is extracted in a channel-before-spatial manner, and the input feature map is multiplied with an original feature map to feed back after each attention extraction.

In an embodiment of the present disclosure, the texture pattern of the randomly simulated abnormality enhances a diversity of a simulated defect by randomized data augmentation, and wherein three of the following are randomly selected and combined for usage: rotation, affine transformation, image brightness, sharpness, equalization value, contrast and saturation.

In an embodiment of the present disclosure, a compressed image Iᵣ and the abnormal binary image Pₜ overlap each other to obtain a simulated abnormal portion comprising original image information, while the compressed image Iᵣ and the reverse value image of the abnormal binary image Pₜ overlap each other to obtain an image region portion without the simulated abnormality.

Advantages of the present disclosure are as follows.

(1) More realistic simulation of industrial abnormal defects and preservation of image defect features are achieved based on abnormal simulation of Berlin noise and industrial images equally scaled, providing a foundation for the training of abnormality reconstruction networks.

(2) Compared to the application of basic semantic segmentation methods in the industrial defect detection, adopting a semi-supervised contrastive learning structure of “abnormality reconstruction+contrastive discriminative” is capable of better utilizing the information value of normal samples, thereby reducing model data dependence.

(3) The self-supervised learning module of mask dilated convolution is used to enhance the ability of image restoration and reconstruction, providing convenient conditions for contrastive learning.

(4) A self-attention mechanism facing spatial and channel level of CNN is used to self-learn the information of contrastive images, improving the final segmentation detection effect.

### BRIEF DESCRIPTION OF DRAWINGS

In order to more clearly illustrate the embodiments of the present disclosure or the technical solutions in the related art, the drawings that need to be used in the description of the embodiments or the related art will be briefly described below. Obviously, the drawings in the following description are only some embodiments of the present disclosure, and for those skilled in the art, other drawings may further be obtained according to these drawings without inventive effort.

FIG. 1 is a training phase flowchart of the abnormality reconstruction network for normal samples of the present disclosure;

FIG. 2 is a training phase flowchart of the contrastive discriminative network for abnormal samples of the present disclosure; and

FIG. 3 is a flowchart for simulating abnormal defects of the present disclosure.

### DESCRIPTION OF EMBODIMENTS

The preferred embodiments of the present disclosure will now be described with reference to the drawings. In order to clarify the structural process characteristics and functions of the present disclosure more clearly, the method of the present disclosure is divided into three parts for detailed explanation.

1. Abnormal data simulation.

(1) The steel surface data in the real industrial scene is obtained, the images of machine tool area taken from different perspectives are selected to form a dataset, the data with the surface defect is taken as the abnormal sample, and the data without the surface defect is taken as the normal sample. The surface defect comprises edge cracks and creases.

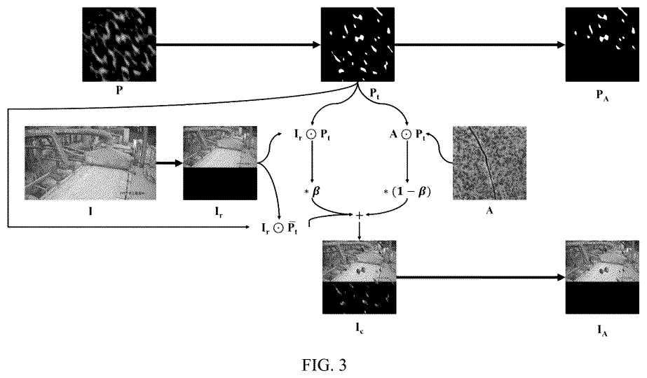

(2) A noise image P is randomly generated from Perlin noise effectively simulating various random defects and abnormal defects of different shapes and sizes. Due to not initially a binary image, the Perlin noise cannot be directly used as a defect abnormality image. It is necessary to perform a binary operation through a randomly uniformly sampled threshold to obtain an image Pₜ as shown in FIG. 3.

(3) For abnormality simulation, it is not only required to use the binary image Pₜ to randomize the position of simulated defects, but also to randomize the texture information of defects at the same time. The present disclosure randomly selects different texture as defect textures, and A in FIG. 3 is a randomly selected abnormal defect texture pattern. Based on the defect texture, the randomized data augmentation is needed to enhance the diversity of the simulated defect, including rotation, affine transformation, image brightness, sharpness, equalization value, contrast, saturation and the like, three of which are randomly selected and combined for usage. The enhanced A and the abnormal binary image Pₜ overlap each other to obtain random textures and an enhanced simulated abnormal defect portion.

(4) For an original image I, since the images in the dataset are all 1440×2560 resolution size, considering that most images have small defects, when the resolution size of the image is forced to be compressed to 256×256 to match the resolution size of network input, resulting in significant loss of information on the small defects. Therefore, the present disclosure first overlays the original image with a 2560×2560 square image, and then entirely compresses the images with the resolution size of 256×256. By preserving the shape information of small defects to a certain extent for subsequent detection, the compressed image Iᵣ as shown in FIG. 3 is ultimately obtained. The abnormal binary image Pₜ overlap each other to obtain the simulated abnormal portion comprising the original image information, while the compressed image Iᵣ and the reverse value image of the abnormal binary image Pₜ overlap each other to obtain the image region portion without the simulated abnormality.

Finally, as shown in FIG. 3, the enhanced simulated abnormal defect portion, the simulated abnormal portion, and the image region portion are mixed to obtain the simulated abnormal sample image I_{c}:

$${I}_{c} = {I}_{r} ⊙ \overline{{P}_{t}} + β ( {I}_{r} ⊙ {P}_{t} ) + ( 1 - β ) ( A ⊙ {P}_{t} )$$

Where β represents the proportion coefficient, which is the fusion ratio between the original image and a simulated abnormal defect. This not only designs a random noise abnormality, but also combines the information of the original image, making the final simulated defect abnormality information closer to the pixel distribution characteristics of the original image. ⊙ represents a dot multiplication operation pixel by pixel between image matrices, and P̅ₜ̅ represents a reverse value image of an abnormal binary image Pₜ.

Due to the consideration of the actual range, region truncation is performed on the simulated abnormal images I_{c} and the simulated abnormality Pₜ to obtain the final results I_{A} and P_{A}.

2. Construction of the abnormality reconstruction network and the contrastive discriminative network.

(1) A semi-supervised contrastive learning architecture of “abnormality reconstruction+contrastive discriminative” is constructed. For the network structure, a two-stage semi-supervised learning training mode is designed herein, including first training normal samples and reconstructed network, followed by training abnormal samples and discriminative networks. The reconstructed network can be a generator of GAN or a structural model of the encoder-decoder based on a FCN network to implement convolutional networks for downsampling and upsampling of basic features. The contrastive discriminative network can be a basic semantic segmentation network such as UNet, SegNet, DeepLab, to fully utilize the information value of previously unusable normal samples, thus playing a crucial role in reconstructing abnormal samples.

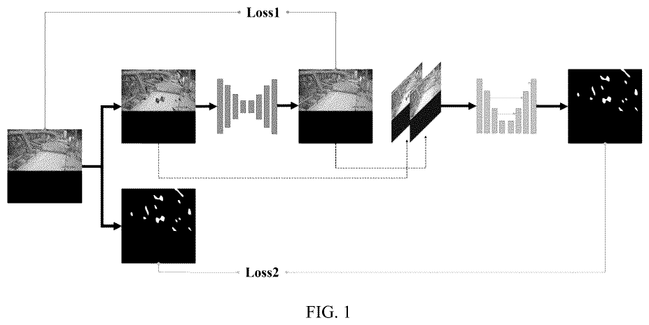

(2) In first stage shown in FIG. 1, only the simulated abnormal samples of normal samples are input for learning. The abnormality reconstruction network is learned to generate “de-anomaly” sample output, thereby obtaining reconstruction recovery samples. Then the training loss (Loss1 in FIG. 1) of the actual normal samples is calculated and the abnormality reconstruction network is trained to obtain one stable abnormality reconstruction network. It should be noted that the normal samples do not have any annotations, so the subsequent contrastive discriminative networks can be selectively trained. The optimization of the training loss (Loss2 in FIG. 1) of the contrastive discriminative network is mainly carried out in second stage. In addition, the simulated abnormal samples generated during the normal sample training stage only simulate defect abnormalities and cannot simulate the segmentation of machine tool area positioning, so the first stage does not involve training learning of the machine tool area positioning.

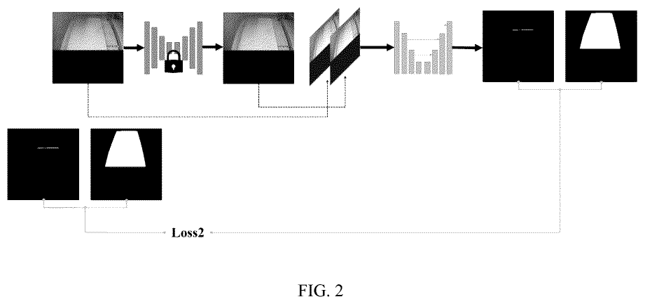

(3) In the second stage shown in FIG. 2, only abnormal samples are input into the pre-trained abnormality reconstruction network to generate “de-anomaly” industrial real image samples. Then, the industrial real image samples are combined with the input abnormal samples for channel merging and input together into the contrastive discriminative network to learn and output the defect detection results and machine tool area positioning results. The second stage does not make any training adjustments to the abnormality reconstruction network trained in the first stage, but directly restores the abnormal samples, providing good conditions for the contrastive learning.

3. Optimization design for the abnormality reconstruction network and the contrastive discriminative network.

(1) For the abnormality reconstruction network, the mask dilated convolution module (Self-Supervised Predictive Convolutional Attention Block for Anomalous Detection) is used to expand the receptive field of the abnormality reconstruction network, achieving the ability to aggregate information around pixels, and better predicting the current pixel restoration results. At the same time, Transformer is used to replace the basic fully connected integration operation in feature fusion, better achieving feature aggregation.

The mask dilated convolution requires two parameters to be determined including a dilated rate d and a convolution size k, thus determining that the convolution used is k×k×c, where c is the number of channels in the convolutional kernel.

For one image with h×w×c, the first step is to perform pad extension on the image, extending the distance of k+d around the image to obtain an extended image of (h+2k+2d)×(w+2k+2d)×c.

The extended image is divided into four sub-image blocks: upper left corner, lower left corner, upper right corner, and lower right corner. Each sub-image block has size of (h+k+2d)×(w+k+2d)×c. The four sub-image blocks Pᵢ∈ [symbol] ^{(h+k+2d)×(w+k+2d)×c}, ∀i∈{1,2,3,4} are performed convolution and fusion activation, respectively, which is corresponding to that self-supervised learning is performed on the surrounding four perspectives of each pixel in the original image, predicting the actual value of the pixel, and thus achieving self-supervised learning.

Feature map output Z∈ [symbol] ^{h×w×c} obtained from the mask dilated convolution represents feature map of h×w size obtained from the c mask dilated convolution. Firstly, a spatial average pooling is used to reduce the feature map to obtain the pooled feature map \hat{Z}∈ [symbol] ^{h′×w′×c}, where h′≤h and w′≤w. Next, \hat{Z} is performed a reshape operation based on the channel to obtain flattened features A∈ [symbol] ^{c×n}, where n=h′×w′, and A represents the flattening characteristics of different channels. Afterwards, Tokens T∈ [symbol] ^{c×d}^{ₜ} is extracted from A through a linear layer, where dₜ represents the dimension of each channel's Token. Tokens adds positional encoding to obtain the final Tokens T*∈ [symbol] ^{c×d}^{ₜ}. Finally, the multi-head attention mechanism is used to complete the learning training of Tokens, obtaining the feature maps with self-attention, and optimizing the image restoration ability of the abnormality reconstruction network.

(2) The Self-Attention Mechanism Module of the Contrastive Discriminative Network

For two samples with segmented abnormal defect differences inputted by the contrastive discriminative network, the scheme of channel attention module before spatial attention module is adopted:

For the channel attention module, the method of compressing feature map space is adopted, which is different from the commonly adopted average pooling method to obtain attention. Convolution Block Attention Module CBAM effectively calculates spatial information statistics by adopting the average pooling method and maximum pooling method, collecting attention features of different channels, and improving network representation ability.

For the spatial attention module, the average pooling method and the maximum pooling method are adopted to compress channel dimension, effectively calculating the information statistics on the channel, and finally obtaining the attention features of different spaces.

Finally, combining two attention modules, for the feature maps, attention is extracted in a channel-before-spatial manner, and the feature maps are multiplied with an original feature map to feed back after each attention extraction, thereby obtaining the final attention mechanism module and improving the final effect of industrial defect detection.

The steel surface defect dataset used in this embodiment includes 2387 training set images in which there were 338 normal samples and 2049 abnormal samples, and 175 test set images. Each type of sample includes four different perspective images, among which the normal samples were not labeled. A certain number of images are randomly selected from four different perspectives as the test data for each perspective image in the test set, respectively, ultimately obtaining 175 test set images that includes 26 normal samples and 149 abnormal samples for testing.

The abnormal samples in the training set and all samples in the testing set are equipped with two types of data annotation, representing the data annotation for defect detection, respectively, including defect annotation for creases and edge cracks. A pixel level annotation of the machine tool range is mainly used for the annotation of machine tool positioning.

The results from this experiment demonstrate that for the defect detection, the basic semantic segmentation method UNet has a MIOU (i.e., Mean Intersection over Union) of 74.5%. In contrast, the method designed by the present disclosure has a MIOU of 86.3%, and even with 50% abnormal sample data, the MIOU of the method designed by the present disclosure can still reach 77.0%, demonstrating the superiority of the method.

The above embodiments are used to explain the present disclosure, rather than limit the present disclosure, and any modifications and changes made to the present disclosure within the spirit and scope of the claims of the present disclosure will fall within the scope of the present disclosure.

What is claimed is:

1. A method for detecting an abnormal defect on a steel surface based on semi-supervised contrastive learning, comprising:
step (1), obtaining steel surface data in a real industrial scene, selecting images of machine tool area taken from different perspectives, taking data with a surface defect as an abnormal sample, and taking data without the surface defect as a normal sample, wherein the surface defect comprises edge cracks and creases;
step (2), generating an abnormal Perlin noise simulating the real industrial scene by simulating abnormality for the normal sample, and combining with the normal sample equally scaled to obtain a simulated abnormal sample image I_{c}:
$${I}_{c} = {I}_{r} ⊙ \overline{{P}_{t}} + β ( {I}_{r} ⊙ {P}_{t} ) + ( 1 - β ) ( A ⊙ {P}_{t} )$$
where Iᵣ represents a compressed image equally scaled for a normal sample image I, A represents a texture pattern of a randomly simulated abnormality, and Pₜ represents a binary image of a random Berlin noise image P, β is a proportion coefficient, representing a fusion ratio between the normal sample image and a simulated abnormal defect, ⊙ represents a dot multiplication operation pixel by pixel between image matrices, and P̅ₜ̅ represents a reverse value image of an abnormal binary image Pₜ;
step (3), constructing an abnormality reconstruction network based on an encoder-decoder structure for learning how to restore and reconstruct the abnormal sample into the normal sample, using the simulated abnormal sample of the step (2) as a network input, obtaining a reconstructed recovery sample, calculating a loss relative to the normal sample, and training the abnormality reconstruction network; and
step (4), constructing a contrastive discriminative network based on semantic segmentation, inputting the abnormal sample of the step (1) into the trained abnormality reconstruction network to obtain a reconstructed recovery sample, combining a channel with a input abnormal sample as an input of the contrastive discriminative network, obtaining a difference between the reconstructed recovery sample and the input abnormal sample by contrastive learning, and outputting a steel surface defect detection result.

2. The method according to claim 1, wherein a mask dilated convolution module is embedded in an encoder of the abnormality reconstruction network to expand a receptive field of the abnormality reconstruction network, and a transformer is used to replace a full connection integration operation of the mask dilated convolution module to achieve feature aggregation.

3. The method according to claim 2, wherein for the contrastive discriminative network, a self-attention mechanism module is used to obtain channel and spatial self-attention input by the contrastive discriminative network, so as to optimize the steel surface defect detection result.

4. The method according to claim 3, wherein for an input feature map of the contrastive discriminative network, attention is extracted in a channel-before-spatial manner, and the input feature map is multiplied with an original feature map to feed back after each attention extraction.

5. The method according to claim 1, wherein the texture pattern of the randomly simulated abnormality enhances a diversity of a simulated defect by randomized data augmentation, and wherein three of the following are randomly selected and combined for usage: rotation, affine transformation, image brightness, sharpness, equalization value, contrast and saturation.

6. The method according to claim 1, wherein the compressed image Iᵣ and the abnormal binary image Pₜ overlap each other to obtain a simulated abnormal portion comprising original image information, and the compressed image Iᵣ and the reverse value image of the abnormal binary image Pₜ overlap each other to obtain an image region portion without the simulated abnormality.
